(19) United States
(12) Patent Application Publication
(10) Pub. No.: US 2009/0280353 A1
(43) Pub. Date: Nov. 12, 2009

(54) AUTOMOTIVE MOLDING WITH CONTROLLED METALLIC LUSTER

(75) Inventor: Hidenori HIRAI, Ibara-Shi (JP)

Correspondence Address: BURR & BROWN, PO BOX 7068, SYRACUSE, NY, 13261-7068, US

(73) Assignee: Katayama Kogyo Co., Ltd., Ibara-Shi (JP)

(21) Appl. No.: 12/500,166

(22) Filed: Jul. 9, 2009

Related U.S. Application Data
(63) Continuation of application No. PCT/JP2008/050134, filed on Jan. 9, 2008.

(30) Foreign Application Priority Data
Jan. 10, 2007 (JP) 2007-001875
Aug. 3, 2007 (JP) 2007-203670

(51) Int. Cl. B32B 3/10

(52) U.S. Cl. 428/687; 428/141

(57) ABSTRACT

The metallic luster of a stainless steel material is uniformly controlled by forming minute elevations and depressions on the surface of a stainless steel molding material that has been press-formed or roll-formed.

### CROSS REFERENCE TO RELATED APPLICATION

This application is a continuation of International Patent Application No. PCT/JP2008/050134, having an international filing date of Jan. 9, 2008, which designated the United States, the entirety of which is incorporated herein by reference. Japanese Patent Application No. 2007-001875 filed on Jan. 10, 2007 and Japanese Patent Application No. 2007-203670 filed on Aug. 3, 2007 are also incorporated herein by reference in their entirety.

### BACKGROUND

The present invention relates to a stainless steel molding used for automobiles. More particularly, the invention relates to an automotive molding of which the metallic luster is controlled by blasting or electropolishing the stainless steel molding material.

A molding formed using a stainless steel plate has been widely used as automotive exterior parts.

As shown in FIG. 2, a sash molding 1, a beltline molding 2, a module molding 3, and the like are provided around a side window of an automobile to form an exterior design, for example.

The sash molding 1 is provided on the external design surface of a door sash. The sash molding 1 is produced to have a given cross-sectional shape and a given bent shape by roll forming or press forming. When forming the sash molding 1 using a stainless steel plate, an area having a small radius of curvature is whitened so that the appearance is impaired.

This also applies to the beltline molding 2.

The module molding 3 shown in FIG. 2 is generally produced by punching out a material from a stainless steel plate and press-forming the material. The module molding 3 may be formed using a rolled steel plate. A rolled steel plate generally has streaks due to rolling. Since an area that is cut in the transverse direction and an area that is cut in the vertical direction differ in streak direction, the appearance of the design surface may become non-uniform.

A protective tape is attached to a stainless steel plate during press forming in order to prevent scratches. However, it is difficult to completely prevent scratches and die marks. This results in a decrease in yield.

Therefore, buff polishing has been employed to prevent scratches and whitening of the design surface. However, an area subjected to buff polishing may have a color differing from that of other areas, or a resin member attached to the molding may be damaged.

A long material (e.g., beltline molding or sash molding) is generally roll-formed, and a relatively short material (e.g., corner garnish or module molding) or a three-dimensional material is generally press-formed. A difference in appearance occurs due to the forming method so that a uniform design may not be achieved.

A stainless steel molding has high luster immediately after production, but loses luster due to wind and rain.

The design of an automobile may be impaired by a stainless steel molding having high luster.

In view of the above-described problems, a satin stainless steel molding with reduced metallic luster (may be referred to as pearskin finish) has been desired. A satin stainless steel molding has been generally produced by bonding a satin resin film, coating, or plating.

When bonding a resin film, if the design surface is a three-dimensional curved surface or the center of a design surface 100 (see FIG. 7) has a depression, a resin film adheres to protrusions 111a and 111b. Therefore, the resin film tends to wrinkle so that the film cannot be uniformly bonded. Moreover, a resin film has low weatherability.

When using a coating method, if a resin member is bonded to the molding, an area other than the coating area must be masked so that the production cost increases. Moreover, it is difficult to form a metallic coating.

A plating method increases cost, and makes it difficult to control metallic luster.

JP-A-2007-125684 discloses a shot blasting coloring method. However, the method disclosed in JP-A-2007-125684 cannot be applied to an automotive molding since JP-A-2007-125684 does not aim at an automotive molding.

JP-A-2000-282300 discloses technology that electropolishes a stainless steel plate so that the stainless steel plate is not contaminated. However, JP-A-2000-282300 mainly aims at allowing elevations and depressions to remain. Therefore, the method disclosed in JP-A-2000-282300 cannot be directly applied to an automotive molding.

### SUMMARY

In view of the above-described situation, an object of the invention is to provide an automotive molding that ensures that stainless steel moldings of an automobile exhibit high exterior design uniformity and has controlled metallic luster.

According to one aspect of the invention, there is provided an automotive molding comprising: a stainless steel molding material that has been press-formed or roll-formed; and minute elevations and depressions formed on a surface of the stainless steel material, metallic luster of the surface of the stainless steel material being uniformly controlled.

In one aspect of the invention, the meaning of uniformly controlling the metallic luster of the surface of the stainless steel is as follows. At the surface of stainless steel before forming the minute elevations and depressions, there are whitened area formed at bent portion. There are also scratches and die marks. After forming the minute elevations and depressions, the difference of the metallic luster between whitened area and surrounding area thereof becomes smaller. In the same manner, the difference of the metallic luster between scratches and surrounding area thereof becomes smaller, and the difference of the metallic luster between die marks and surrounding area thereof becomes smaller. In this way, metallic luster of the surface of the stainless steel is uniformly controlled.

The minute elevations and depressions may be formed by blasting or electropolishing the surface of the stainless steel material that has been press-formed or roll-formed.

An area of the stainless steel molding material having a small radius of curvature is whitened due to press forming or roll forming. However, the whitened area is observed to only a small extent by forming minute elevations and depressions on the surface of the stainless steel molding material so that a uniform appearance is obtained.

If necessary, the surface of the stainless steel molding material may be subjected to washing with an acid (e.g., sulfuric acid or nitric acid), chemical polishing, or electropolishing.

The metallic luster of the stainless steel molding material can be uniformly controlled by suppressing the metallic luster by adjusting the size of minute elevations and depressions and reducing the reflectivity by chemical polishing or electropolishing, if necessary.

When minute elevations and depressions are formed on the surface of the stainless steel material that has been press-formed or roll-formed by blasting or electropolishing, whitening of the bent portion is observed to only a small extent due to irregular reflection owing to the elevations and depressions, and a satin surface with reduced metallic luster is obtained.

The term “satin” refers to a color tone with reduced metallic luster (may be referred to as pearskin finish).

Blasting is an inexpensive means for forming minute elevations and depressions on the surface of stainless steel after press forming or roll forming. For example, sand blasting or shot blasting using glass beads, resin beads, SS beads, ceramic beads, or the like may be applied.

When the thickness of the molding is small, it is preferable to hit the shots against each side of the molding to prevent deformation of the molding.

When using a material having a relatively low hardness (e.g., glass beads or resin beads) as the shots, minute elevations and depressions can be formed while relatively maintaining metallic luster (i.e., the entire material is polish-finished).

In the field of automotive moldings, a resin member may be bonded to a stainless steel molding material, a stainless steel molding core material and a resin may be co-extruded and bonded, or a resin member may be bonded to a stainless steel press forming material by injection molding.

Such a composite molding of a stainless steel plate and a resin member may be directly blasted or electropolished.

When using a composite molding of a stainless steel plate and a resin member, it is preferable to use a soft shot material (e.g., glass beads or resin beads) so that the surface of the resin member is not roughened to a large extent.

When using a resin member formed of a soft resin, a satin stainless steel surface can be obtained without damaging the resin member by utilizing a soft shot material.

When controlling the color tone by applying electropolishing or applying electropolishing after shot blasting as a means for forming minute elevations and depressions on the surface of the stainless steel molding material, the color tone can be easily controlled when using a ferritic stainless steel plate (equivalent to SUS430 defined in JIS: Japanese Industrial Standard) as the stainless steel plate so that a satin appearance with smooth and soft luster can be obtained.

Since the thickness of an oxide film formed on the surface of the stainless steel plate increases by applying electropolishing, the stainless steel plate exhibits improved corrosion resistance.

The color tone of the surface of a stainless steel material can be controlled without damaging the resin member by blasting a stainless steel molding material obtained by roll-forming a stainless steel plate and bonding a soft resin member to the stainless steel plate by co-extrusion, or a stainless steel molding material obtained by press-forming a stainless steel plate and bonding a soft resin member to the stainless steel plate by injection molding using glass beads or resin beads. Note that a method that blasts a roll-formed stainless steel plate and bonds a resin member to the stainless steel plate by co-extrusion, or a method that blasts a press-formed stainless steel plate and bonds a resin member to the stainless steel plate by injection molding may also be used. As a result, the resin material physically adheres to the minute elevations and depressions formed on the surface of the stainless steel molding material so that the adhesion between the stainless steel material and the resin member can be improved while controlling the color tone of the stainless steel material.

A straight material that has been roll-formed and extruded may be subjected to a satin treatment, and may then be bent.

According to the invention, since minute elevations and depressions are formed on the surface of the automotive molding by blasting or electropolishing after press-forming or roll-forming a stainless steel plate, whitening of the bent portion or the like is observed to only a small extent. Moreover, since the automotive molding has a uniform exterior design, high overall uniformity is achieved even when a roll-formed product is combined with a press-formed product.

Since a die mark or scratches that may occur during press forming are observed to only a small extent, a high yield is achieved.

Since a satin appearance with soft luster is obtained by blasting the surface of a stainless steel plate, a novel automobile design can be obtained.

A polished surface with metallic luster can also be obtained by reducing the shot pressure during blasting or selecting shots with low hardness.

Reflected light is doubled by polishing the surface (i.e., depth is achieved).

A change with time due to wind and rain decreases by forming a surface having a soft color tone.

According to related art, a bent portion having a small radius of curvature must be disposed at a position where the bent portion cannot be seen, or the radius of curvature of the bent portion must be increased when designing an automobile molding. According to the invention, since a bent portion having a small radius of curvature can be disposed on the design surface, the degree of freedom of the design increases.

Moreover, the blasted surface of the molding is contaminated by fingerprints or the like to only a small extent.

Therefore, while related art has a problem as to durability (e.g., a resin film or coating is easily removed), the invention can significantly improve the durability of the automobile molding.

### BRIEF DESCRIPTION OF THE DRAWINGS

FIGS. 1A to 1E are enlarged views showing a design surface of a stainless steel molding according to the invention.

FIG. 2 shows a configuration example of a molding provided around a side window of an automobile.

FIG. 3 shows an example of the cross section of a sash molding along the line III-III shown in FIG. 2.

FIG. 4 shows an example of the cross section of a beltline molding along the line IV-IV shown in FIG. 2.

FIG. 5 shows an example of a production step of an automotive molding.

FIG. 6A is a perspective view showing an example in which the invention is applied to a scuff plate, and FIG. 6B is a cross-sectional view along the line VI-VI shown in FIG. 6A.

FIG. 7 shows an example in which a resin film is attached to the design surface of a molding.

### DESCRIPTION OF EXEMPLARY EMBODIMENTS

A sash molding 1 shown in FIG. 3 that is attached to the outer surface of a door sash 11 was press-formed and blasted using glass beads in a state in which a resin member 1a was bonded.

A bent portion R having a small radius of curvature shown in FIG. 3 was whitened before blasting. However, whitening was not observed after blasting so that a uniform satin appearance was obtained.

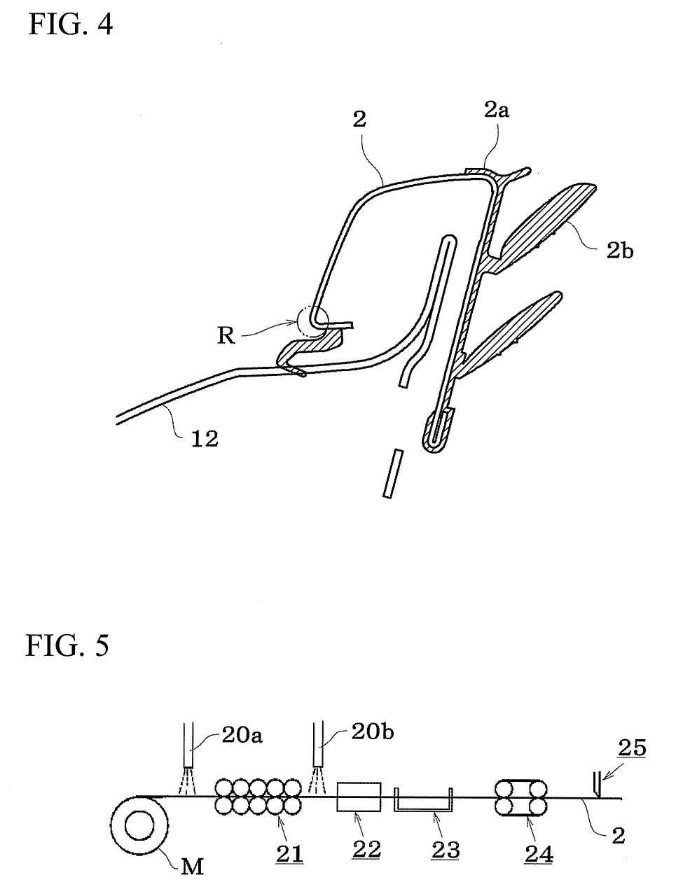

A beltline molding 2 shown in FIG. 4 that is attached to a door panel 12 was roll-formed, and extruded together with a resin member 2a having a lip 2b to obtain a product.

A bent portion R shown in FIG. 4 was whitened in this state. However, whitening was not observed after blasting the beltline molding 2 in the same manner as the sash molding 1 (i.e., a molding having an appearance similar to that of the sash molding 1 was obtained).

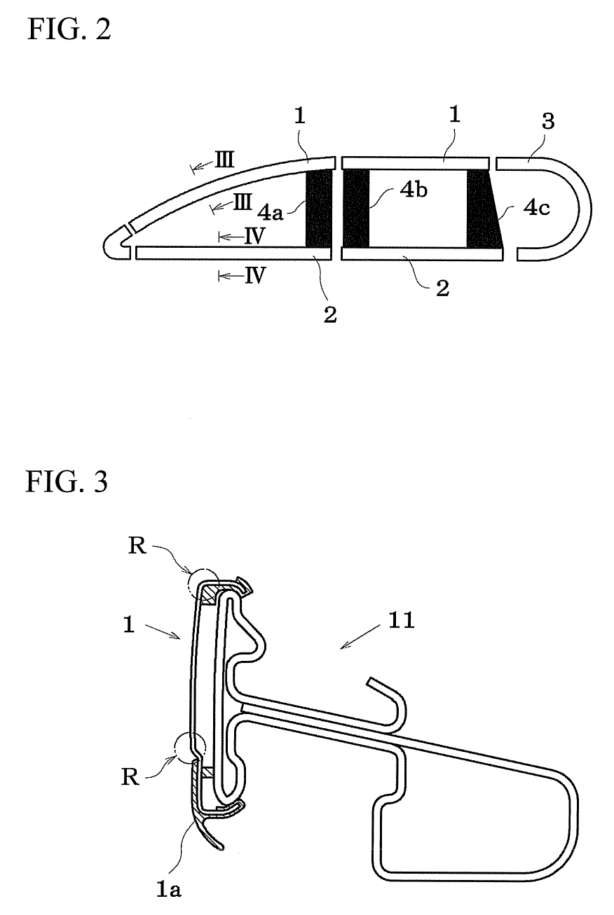

A module molding 3 shown in FIG. 2 was obtained by attaching a protective tape to a stainless steel plate and press-forming the resulting product. A die mark was observed after removing the protective tape. However, the die mark disappeared after blasting performed in the same manner as described above so that a satin appearance was obtained.

The above-described moldings were assembled around a side window of an automobile, as shown in FIG. 2. A novel satin automotive molding assembly was thus obtained.

In FIG. 2, symbols 4a, 4b, and 4c indicate pillars.

The sash molding 1 shown in FIG. 3 was press-formed, sand-blasted in a state in which the resin member 1a was bonded, and electropolished using a sodium bichromate solution.

The bent portion R shown in FIG. 3 was whitened before blasting. However, the whitened area was observed to only a small extent after blasting, and a uniform satin appearance was obtained by electropolishing.

Note that SUS430 was used as the stainless steel plate.

The beltline molding 2 shown in FIG. 4 was roll-formed, and extruded together with the resin member 2a having the lip 2b to obtain a product.

The bent portion R shown in FIG. 4 was whitened in this state. However, the whitened area was observed to only a small extent after blasting and electropolishing the beltline molding 2 so that a molding having an appearance similar to that of the sash molding 1 was obtained.

The module molding 3 shown in FIG. 2 that was obtained by attaching a protective tape to a stainless steel plate and pressing the resulting product showed a die mark after removing the protective tape. However, the die mark disappeared after blasting and electropolishing the module molding 3 so that a satin appearance was obtained.

The above-described moldings were assembled around a side window of an automobile, as shown in FIG. 2. A novel satin automotive molding assembly was thus obtained.

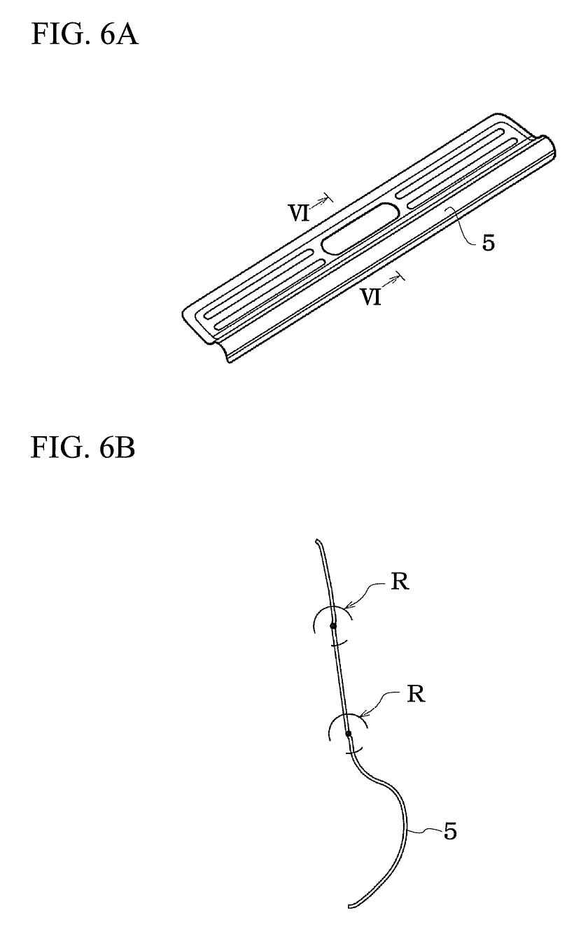

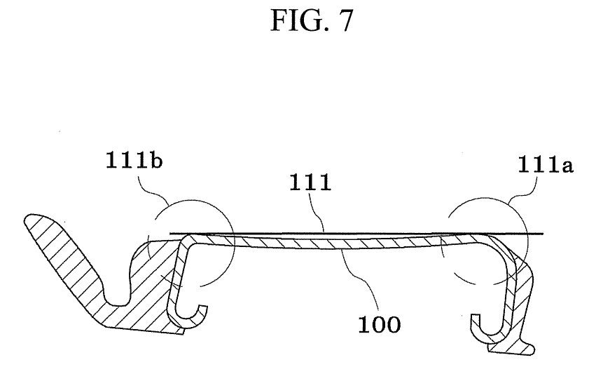

A scuff plate 5 shown in FIGS. 6A and 6B is attached to the edge of the opening of an automotive door in order to protect the side seal.

In this case, whitening of a bent portion R was observed to only a small extent after blasting and electropolishing the scuff plate 5.

A scuff plate is provided at a position where the scuff plate tends to be hit and damaged by the passenger. Therefore, damage to the design surface caused by the passenger becomes less prominent by applying a satin finish while suppressing luster.

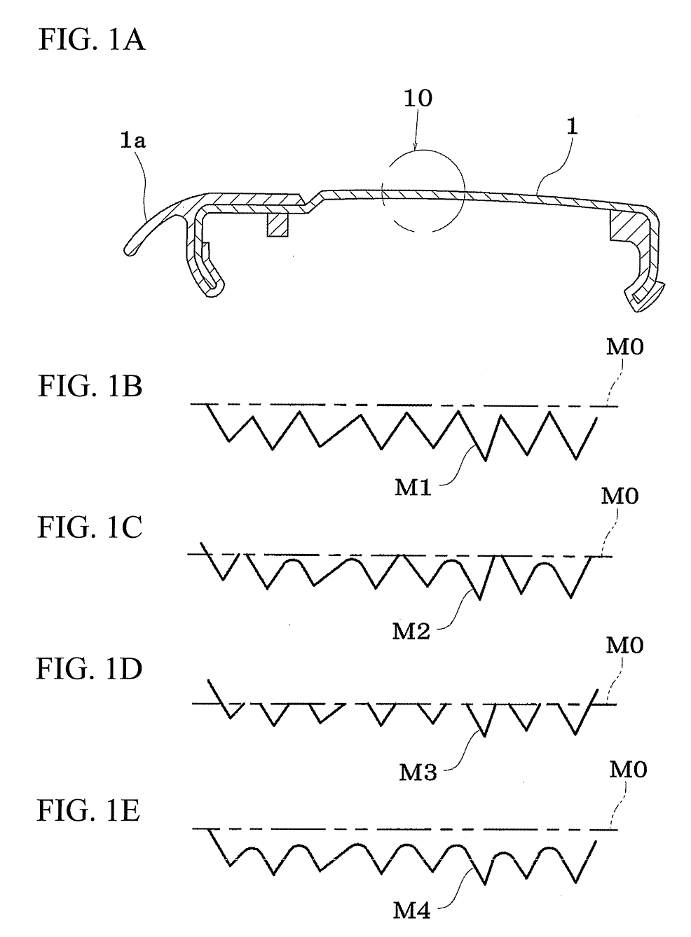

An example of forming minute elevations and depressions in the stainless steel material according to the invention is described below with reference to FIGS. 1A to 1E (schematic views).

As shown in FIG. 1A, the resin member 1a is bonded to the press-formed sash molding 1.

FIGS. 1B to 1E are enlarged views showing a design surface 10 of the sash molding 1.

In FIGS. 1B to 1E, a dash-dot-dot line M0 indicates an imaginary line before forming minute elevations and depressions on the surface.

FIG. 1B shows an example of the design surface 10 that has been subjected to relatively strong blasting. Specifically, an uneven surface M1 is formed so that the original material surface disappears. In this case, a satin appearance with weak metallic luster is obtained.

FIG. 1C shows an example of the design surface 10 on which minute elevations and depressions are formed by electropolishing. The top of the elevations is rounded to some extent.

FIG. 1D shows an example of the design surface 10 that is blasted using glass beads 300#. In this case, the surface of the material partially remains and is polished (M3) so that metallic luster is increased (i.e., depth is achieved).

FIG. 1E is a schematic view showing an example in which electropolishing or washing with an acid was performed after blasting. The surface of the stainless steel material has been removed by electropolishing or washing with an acid.

In the embodiments of the invention, elevations and depressions may be formed on the surface of the stainless steel molding material after bonding the resin member to the stainless steel molding material. Alternatively, the resin member may be extruded together with the stainless steel molding material after blasting the stainless steel plate. An example of the latter is described below with reference to FIG. 5.

A stainless steel material M is unwound from a drum, and roll-formed to a given cross-sectional shape using a roll forming machine 21.

Since blasting may cause scratches during rolling, it is preferable to dispose a shot machine 20b on the downstream side of the roll forming machine 21. Note that the shot machine 20b may be disposed on the upstream side of the roll forming machine 21.

The blasted stainless steel molding material 2 is extruded together with the resin member using a co-extruder 22, passed through a cooler 23, continuously drawn by a drawing machine 24, and cut into a specific length by a cutting machine 25.

The adhesion of the resin member is improved by blasting the material before co-extrusion with the resin member.

The invention may be applied to an automotive stainless steel molding of a novel design that may replace a known automotive stainless steel molding, and is effective when finishing the surfaces of various moldings formed by different methods such as pressing and rolling (e.g., a side window of an automobile).

Although only some embodiments of the invention have been described in detail above, those skilled in the art will readily appreciate that many modifications are possible in the embodiments without materially departing from the novel teachings and advantages of the invention. Accordingly, all such modifications are intended to be included within scope of the invention.

What is claimed is:

1. An automotive molding comprising:
a stainless steel molding material that has been press-formed or roll-formed; and
minute elevations and depressions formed on a surface of the stainless steel material,
metallic luster of the surface of the stainless steel material being uniformly controlled.

2. The automotive molding according to claim 1,
the minute elevations and depressions being formed by blasting the surface of the stainless steel material.

3. The automotive molding according to claim 2,
the surface of the stainless steel material being polished to have the metallic luster by blasting the surface of the stainless steel material with a shot material that is glass beads or resin beads.

4. The automotive molding according to claim 2,
the metallic luster of the surface of the stainless steel material being controlled by treating the surface of the stainless steel material that has been blasted with an acid.

5. The automotive molding according to claim 2,
the metallic luster of the surface of the stainless steel material being controlled by electropolishing the surface of the stainless steel material that has been blasted.

6. The automotive molding according to claim 5,
the stainless steel molding material being a ferritic stainless steel plate.

7. The automotive molding according to claim 1,
the minute elevations and depressions being formed by electropolishing the surface of the stainless steel material.

8. The automotive molding according to claim 7,
the stainless steel molding material being a ferritic stainless steel plate.

9. The automotive molding according to claim 1,
a resin member being bonded to the stainless steel molding material.

10. The automotive molding according to claim 9,
the resin member being bonded to the minute elevations and depressions formed on the surface of the stainless steel molding material.
